(19) United States
(12) Patent Application Publication
(10) Pub. No.: US 2014/0181711 A1
(43) Pub. Date: Jun. 26, 2014

(54) ELECTRONIC DEVICE AND METHOD FOR INSERTING OBJECTS INTO NOTE-TAKING SOFTWARE OF THE ELECTRONIC DEVICE

(71) Applicant: Chiun Mai Communication Systems, Inc., New Taipei (TW)

(72) Inventor: WEN-YUE WU, New Taipei (TW)

(73) Assignee: CHIUN MAI COMMUNICATION SYSTEMS, INC., New Taipei (TW)

(21) Appl. No.: 14/101,341

(22) Filed: Dec. 10, 2013

(30) Foreign Application Priority Data
Dec. 20, 2012 (TW) 101148595

(51) Int. Cl. G06F 3/0484; G06F 3/0488

(52) U.S. Cl. CPC G06F 3/04842; G06F 3/04883
USPC 715/765

(57) ABSTRACT

A method for an electronic device to insert objects into a note-taking software of the electronic device. The method sets an inserting rule for inserting graphical objects into the note-taking software according to a handwriting track drawn in the note-taking software. A current hand drawn object in the note-taking software is obtained. The method determines whether the current hand drawn object is a character or a control command. When the current hand drawn object is a control command, the method determines which graphical object is to be inserted into the note-taking software according to the inserting rule and the current hand drawn object, and inserts the graphical object into a user interface of the note-taking software constituted by the current hand drawn object.

### BACKGROUND

1. Technical Field

Embodiments of the present disclosure relate to note-taking software technology, and particularly to an electronic device and a method for inserting objects into a note-taking software of the electronic device.

2. Description of Related Art

Note-taking software is installed in electronic devices to provide note-taking functions for a user to take notes on the electronic device. Notes taken by the user can include characters or graphical objects, wherein the graphical objects comprise images captured by the electronic device, or figures drawn by a user. However, to insert graphical objects into the note-taking software, a user must navigate through a plurality of menu buttons. Furthermore, a size and/or position of the graphical objects may need to be adjusted after the graphical objects are inserted into a user interface of the note-taking software, which is inefficient and inconvenient. Therefore, there is room for improvement in the art.

### BRIEF DESCRIPTION OF THE DRAWINGS

FIG. 1 is a schematic diagram of one embodiment of an electronic device comprising an object inserting system.

FIG. 2 is a flowchart illustrating one embodiment of a method for inserting objects into a note-taking software of the electronic device of FIG. 1.

### DETAILED DESCRIPTION

The disclosure, comprising the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may comprise CDs, DVDs, BLU-RAY, flash memory, and hard disk drives.

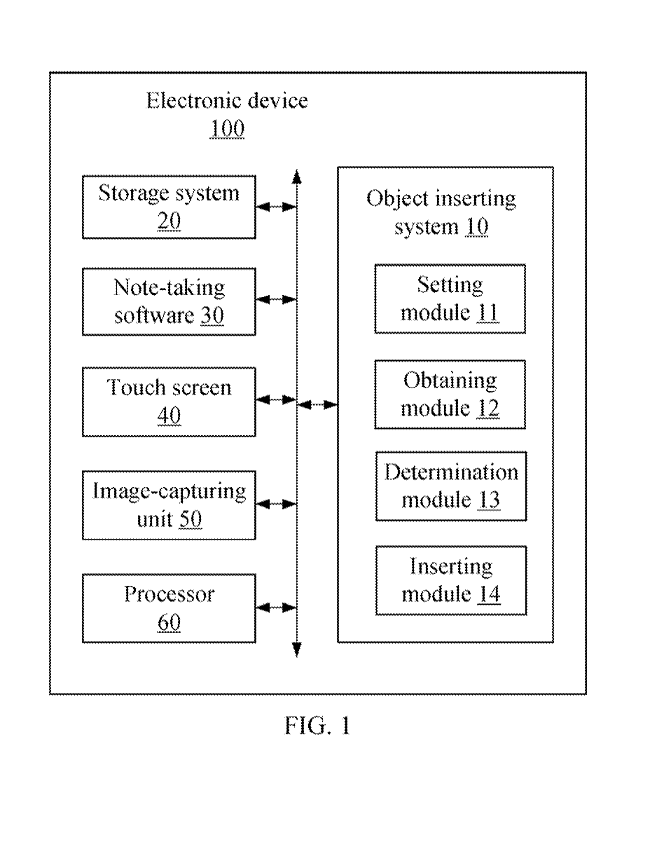

FIG. 1 is a schematic diagram of one embodiment of an electronic device 100 comprising an object inserting system 10. The electronic device 100 can be, but is not limited to be, a mobile phone, a notebook computer, or a personal digital assistant (PDA). The electronic device 100 further comprises a storage system 20, a note-taking software 30, a touch screen 40, an image-capturing unit 50, and a processor 60. The note-taking software 30 provides note-taking functions for a user to take notes on the electronic device 100. Notes taken by the user can be, but are not limited to be, characters or graphical objects, wherein the graphical objects comprise images of a target object captured by the image-capturing unit 50, and figures drawn by the user in the note-taking software 30. The figures can be mathematical formulae, various charts, tables, diagrams, or the like. The target object can be contents of a structure (i.e., a blackboard).

The image-capturing unit 50 comprises a camera that can be, but is not limited to, a charge-coupled device (CCD) or complementary metal-oxide semiconductor (CMOS) image sensors. The storage system 20 can be a memory (e.g., random access memory, flash memory, or hard disk drive) of the electronic device 100. The processor 60 executes one or more computerized codes and other applications of the electronic device 100 to provide functions of the object inserting system 10.

The touch screen 40 displays the notes taken by the user and allows the user to input notes through the note-taking software 30. When the note-taking software 30 is running in the electronic device 100, the user can input characters or draw figures on the touch screen 40 through functions provided by the note-taking software 30. The image-capturing unit 50 captures images of the target object that need to be inserted into the note-taking software 30. If the user captures an image of the target object, such as the blackboard, the object inserting system 10 inserts the captured image into the note-taking software 30.

In the embodiment, the object inserting system 10 comprises a setting module 11, an obtaining module 12, a determination module 13, and an inserting module 14. The modules 11-14 comprise computerized codes in the form of one or more programs that are stored in the storage system 20. The computerized codes comprise instructions that are executed by the processor 60 to provide functions for the modules.

The setting module 11 is configured to set an inserting rule for inserting the graphical objects into the note-taking software 30 according to a handwriting track drawn in the note-taking software 30. The handwriting track can be different shapes drawn by the user. The inserting rule can be preset or set by the user. In one embodiment, the inserting rule includes a first rule for inserting images of the target object captured by the image-capturing unit 50 into the note-taking software 30 when the handwriting track is a first predetermined track, and a second rule for inserting figures drawn on the touch screen 40 into the note-taking software 30 when the handwriting track is a second predetermined track. For example, the first predetermined track is rectangular, and the second predetermined track is circular.

In another embodiment, the inserting rule further comprises a third rule for either inserting images or drawing figures when the user draws a third predetermined track, such as a square. The third rule comprises a first predetermined operation and a second predetermined operation. The first predetermined operation can be single-tapping a space bound by the third predetermined track (e.g., the square) to insert an image of the target object, and the second predetermined operation can be double-tapping the space bound by the third predetermined track (e.g., the square) to draw a figure in the note-taking software 30.

The obtaining module 12 is configured to obtain a current hand drawn object in the note-taking software 30. The current hand drawn object can be a character or a control command for inserting a graphical object into the note-taking software 30.

The determination module 13 is configured to determine whether the current hand drawn object is a character or a control command. In the embodiment, the determination module 13 determines a maximum square area of the touch screen 40 for distinguishing whether the current hand drawn object is a character or a control command. For example, the maximum square area is 40 centimeters squared (cm²). If the area of the current hand drawn object is greater than the maximum square area, the determination module 13 determines that the current hand drawn object is a control command. If the area of the current hand drawn object is not greater than the maximum square area, the determination module 13 determines that the current hand drawn object is a character.

The inserting module 14 is configured to import the character corresponding to the current hand drawn object into the note-taking software 30 when the current hand drawn object is a character. In one embodiment, if the current hand drawn object is a Chinese character, the note-taking software 30 provides a list of characters to choose from, and the inserting module 14 imports the chosen character to the note-taking software 30.

The inserting module 14 is configured to determine which graphical object is to be inserted into the note-taking software 30 according to the inserting rule and the current hand drawn object when the current hand drawn object is a control command. In the embodiment, the inserting module 14 determines whether the graphical object is an image of the target object captured by the image-capturing unit 50 or a figure drawn in the note-taking software 30. For example, if the current hand drawn object is rectangular, the graphical object to be inserted is an image of the target object captured by the image-capturing unit 50. If the current hand drawn object is circular, the graphical object is a figure to be drawn in the space bound by the circle drawn by the user on the touch screen 40.

The inserting module 14 is further configured to insert the graphical object into a user interface of the note-taking software 30 constituted by the current hand drawn object. In the embodiment, the user interface of the note-taking software 30 constituted by the current hand drawn object is a smallest encasing box of the current hand drawn object or the space bound by the current hand drawn object.

When the graphical object is an image of the target object captured by the image-capturing unit 50, the inserting module 14 inserts the image of the target object into the user interface of the note-taking software 30 constituted by the current hand drawn object. For example, if the user draws a rectangle greater than 40 cm², the inserting module 14 determines that the user wants to insert an image, the inserting module 14 sets a user interface in the space for inserting the image, and the image-capturing unit 50 is opened to capture the image. The inserting module 14 then inserts the captured image into the space bound by the rectangle.

When the graphical object is a figure drawn in the note-taking software 30, the inserting module 14 inserts the figure into the user interface of the note-taking software 30 constituted by the current hand drawn object. For example, if the user draws a circle greater than 40 cm², the inserting module 14 determines that the user wants to draw a figure, and the inserting module 14 sets a user interface in the space bound by the circle for drawing a figure, such as a graph. The inserting module 14 then inserts the drawn figure into the space bound by the circle.

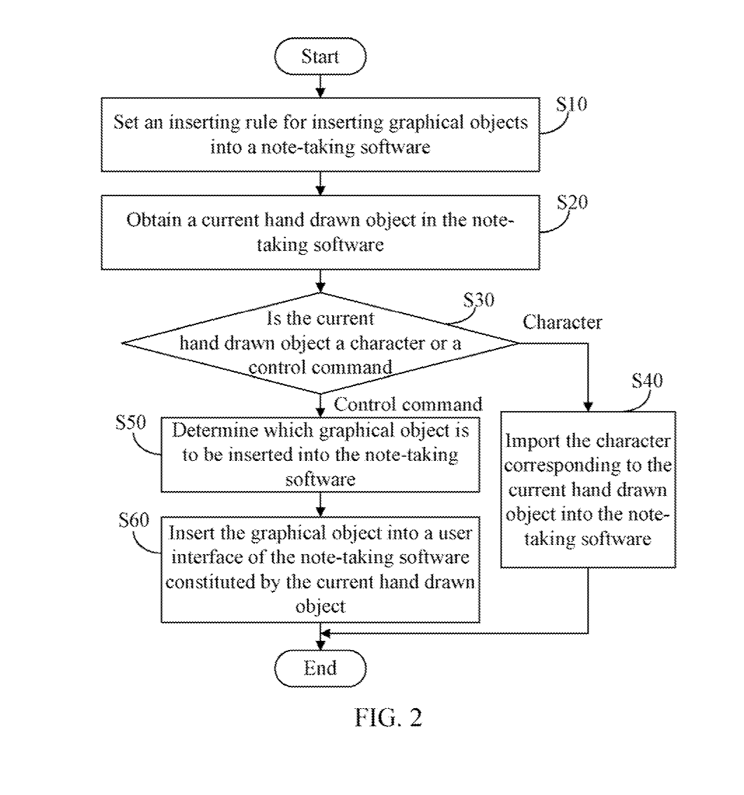

FIG. 2 is a flowchart illustrating one embodiment of a method for inserting objects into the note-taking software 30 of the electronic device 100. Depending on the embodiment, additional steps may be added, others deleted, and the ordering of the steps may be changed.

In step S10, the setting module 11 sets an inserting rule for inserting graphical objects into the note-taking software 30 according to a handwriting track drawn in the note-taking software 30. The graphical objects comprise images of a target object captured by the image-capturing unit 50, and figures drawn in the note-taking software 30.

In step S20, the obtaining module 12 obtains a current hand drawn object in the note-taking software 30. The current hand drawn object can be a character or a control command for inserting a graphical object into the note-taking software 30.

In step S30, the determination module 13 determines whether the current hand drawn object is a character or a control command. If the current hand drawn object is a character, step S40 is implemented. If the current hand drawn object is a control command, step S50 is implemented.

In step S40, the inserting module 14 imports the character corresponding to the current hand drawn object into the note-taking software 30.

In step S50, the inserting module 14 determines which graphical object is to be inserted into the note-taking software 30 according to the inserting rule and the current hand drawn object. In the embodiment, the inserting module 14 determines whether the graphical object is an image of the target object captured by the image-capturing unit 50 or a figure drawn in the note-taking software 30.

In step S60, the inserting module 14 inserts the graphical object into a user interface of the note-taking software 30 constituted by the current hand drawn object. In the embodiment, the user interface of the note-taking software 30 constituted by the current hand drawn object is a smallest encasing box of the current hand drawn object or a space bound by the current hand drawn object. When the graphical object is an image of the target object captured by the image-capturing unit 50, the inserting module 14 inserts the image of the target object into the user interface of the note-taking software 30 constituted by the current hand drawn object. When the graphical object is a figure drawn in the note-taking software 30, the inserting module 14 inserts the figure into the user interface of the note-taking software 30 constituted by the current hand drawn object.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be comprised herein within the scope of this disclosure and the described inventive embodiments, and the present disclosure is protected by the following claims.

What is claimed is:

1. A computer-implemented method for inserting objects into a note-taking software of an electronic device, the method comprising:
setting an inserting rule for inserting graphical objects into the note-taking software according to a handwriting track drawn in the note-taking software, wherein the graphical objects comprise images of a target object captured by an image-capturing unit of the electronic device and figures drawn in the note-taking software;
obtaining a current hand drawn object in the note-taking software;
determining whether the current hand drawn object is a character or a control command; and
determining which graphical object is to be inserted into the note-taking software according to the inserting rule and the current hand drawn object when the current hand drawn object is a control command, and inserting the graphical object into a user interface of the note-taking software constituted by the current hand drawn object.

2. The method as described in claim 1, further comprising:
importing the character corresponding to the current hand drawn object into the note-taking software when the current hand drawn object is a character.

3. The method as described in claim 1, wherein the user interface of the note-taking software constituted by the current hand drawn object is a smallest encasing box of the current hand drawn object or a space bound by the current hand drawn object.

4. The method as described in claim 1, wherein the inserting rule comprises a first rule for inserting images of the target object captured by the image-capturing unit into the note-taking software when the handwriting track is a first predetermined track, and a second rule for inserting figures drawn on a touch screen of the electronic device into the note-taking software when the handwriting track is a second predetermined track.

5. The method as described in claim 1, wherein the inserting rule comprises a third rule for either inserting images of the target object captured by the image-capturing unit into the note-taking software or inserting figures drawn on a touch screen of the electronic device to the note-taking software when the handwriting track is a third predetermined track, wherein the third rule comprises a first predetermined operation to insert the images of the target object and a second predetermined operation to insert the drawn figures.

6. The method as described in claim 1, wherein the step of inserting the graphical object into the user interface of the note-taking software constituted by the current hand drawn object comprises:
determining whether the graphical object is an image of the target object captured by the image-capturing unit or a figure drawn in the note-taking software;
inserting the captured image of the target object into the user interface of the note-taking software constituted by the current hand drawn object when the graphical object is the captured image of the target object; and
inserting the figure into the user interface of the note-taking software constituted by the current hand drawn object when the graphical object is the figure drawn in the note-taking software.

7. An electronic device for inserting objects to a note-taking software of the electronic device, the electronic device comprising:
an image-capturing unit;
at least one processor; and
a computer-readable storage medium storing one or more programs, which when executed by the at least one processor, causes the at least one processor to:
set an inserting rule for inserting graphical objects into the note-taking software according to a handwriting track drawn in the note-taking software, wherein the graphical objects comprise images of a target object captured by the image-capturing unit and figures drawn in the note-taking software;
obtain a current hand drawn object in the note-taking software;
determine whether the current hand drawn object is a character or a control command; and
determine which graphical object is to be inserted into the note-taking software according to the inserting rule and the current hand drawn object when the current hand drawn object is a control command, and insert the graphical object into a user interface of the note-taking software constituted by the current hand drawn object.

8. The electronic device as described in claim 7, wherein the one or more programs further cause the at least one processor to:
import the character corresponding to the current hand drawn object into the note-taking software when the current hand drawn object is a character.

9. The electronic device as described in claim 7, wherein the user interface of the note-taking software constituted by the current hand drawn object is a smallest encasing box of the current hand drawn object or a space bound by the current hand drawn object.

10. The electronic device as described in claim 7, wherein the inserting rule comprises a first rule for inserting images of the target object captured by the image-capturing unit into the note-taking software when the handwriting track is a first predetermined track, and a second rule for inserting figures drawn on a touch screen of the electronic device into the note-taking software when the handwriting track is a second predetermined track.

11. The electronic device as described in claim 7, wherein the inserting rule comprises a third rule for either inserting images of the target object captured by the image-capturing unit into the note-taking software or inserting figures drawn on a touch screen of the electronic device to the note-taking software when the handwriting track is a third predetermined track, wherein the third rule comprises a first predetermined operation to insert the images of the target object and a second predetermined operation to insert the drawn figures.

12. The electronic device as described in claim 7, wherein the one or more programs further cause the at least one processor to:
determine whether the graphical object is an image of the target object captured by the image-capturing unit or a figure drawn in the note-taking software;
insert the captured image of the target object into the user interface of the note-taking software constituted by the current hand drawn object when the graphical object is the captured image of the target object; and
insert the figure into the user interface of the note-taking software constituted by the current hand drawn object when the graphical object is the figure drawn in the note-taking software.

13. A non-transitory computer readable storage medium having stored thereon instructions that, when executed by a processor of an electronic device, causes the processor to insert objects into a note-taking software of the electronic device, the method comprising:
setting an inserting rule for inserting graphical objects into the note-taking software according to a handwriting track drawn in the note-taking software, wherein the graphical objects comprise images of a target object captured by an image-capturing unit of the electronic device and figures drawn in the note-taking software;
obtaining a current hand drawn object in the note-taking software;
determining whether the current hand drawn object is a character or a control command; and
determining which graphical object is to be inserted into the note-taking software according to the inserting rule and the current hand drawn object when the current hand drawn object is a control command, and inserting the graphical object into a user interface of the note-taking software constituted by the current hand drawn object.

14. The non-transitory computer readable storage medium as described in claim 13, wherein the method further comprises:
importing the character corresponding to the current hand drawn object into the note-taking software when the current hand drawn object is a character.

15. The non-transitory computer readable storage medium as described in claim 13, wherein the user interface of the note-taking software constituted by the current hand drawn object is a smallest encasing box of the current hand drawn object or a space bound by the current hand drawn object.

16. The non-transitory computer readable storage medium as described in claim 13, wherein the inserting rule comprises a first rule for inserting images of the target object captured by the image-capturing unit into the note-taking software when the handwriting track is a first predetermined track, and a second rule for inserting figures drawn on a touch screen of the electronic device into the note-taking software when the handwriting track is a second predetermined track.

17. The non-transitory computer readable storage medium as described in claim 13, wherein the inserting rule comprises a third rule for either inserting images of the target object captured by the image-capturing unit into the note-taking software or inserting figures drawn on a touch screen of the electronic device to the note-taking software when the handwriting track is a third predetermined track, wherein the third rule comprises a first predetermined operation to insert the images of the target object and a second predetermined operation to insert the drawn figures.

18. The non-transitory computer readable storage medium as described in claim 13, wherein the step of inserting the graphical object into the user interface of the note-taking software constituted by the current hand drawn object comprises:
determining whether the graphical object is an image of the target object captured by the image-capturing unit or a figure drawn in the note-taking software;
inserting the captured image of the target object into the user interface of the note-taking software constituted by the current hand drawn object when the graphical object is the captured image of the target object; and
inserting the figure into the user interface of the note-taking software constituted by the current hand drawn object when the graphical object is the figure drawn in the note-taking software.
